(19) United States
(12) Patent Application Publication
(10) Pub. No.: US 2017/0047570 A1
(43) Pub. Date: Feb. 16, 2017

(54) HEAT-RESISTANT SYNTHETIC RESIN MICROPOROUS FILM AND METHOD FOR PRODUCING THE SAME, SEPARATOR FOR NON-AQUEOUS ELECTROLYTE SECONDARY BATTERY, AND NON-AQUEOUS ELECTROLYTE SECONDARY BATTERY

(71) Applicant: SEKISUI CHEMICAL CO., LTD., Osaka (JP)

(72) Inventors: Takahiko SAWADA, Osaka (JP); Hiroshi TADA, Osaka (JP)

(73) Assignee: SEKISUI CHEMICAL CO., LTD., Osaka (JP)

(21) Appl. No.: 15/306,153

(22) PCT Filed: Apr. 28, 2015
(86) PCT No.: PCT/JP2015/062836

§ 371 Date: Oct. 24, 2016

(30) Foreign Application Priority Data
May 1, 2014 (JP) 2014-094828

(51) Int. Cl. H01M 2/16; B05D 3/06; C08J 9/36; B05D 7/04

(52) U.S. Cl. CPC H01M 2/1686; B05D 7/04; B05D 3/068; B05D 3/067; H01M 2/1653; C08J 9/365; C08J 2323/12; C08J 2205/044

(57) ABSTRACT

The present invention provides a heat-resistant synthetic resin microporous film having good ion permeability and good heat resistance, and a method for producing the microporous film. The heat-resistant synthetic resin microporous film of the present invention includes a synthetic resin microporous film that has micropore parts, and a coating layer that is formed on at least part of the surface of the synthetic resin microporous film and contains a polymer of a polymerizable compound that has two or more radical-polymerizable functional groups per molecule. The heat-resistant synthetic resin microporous film has a maximum heat shrinkage rate, when heated from 25° C. to 180° C. at a rate of temperature increase of 5° C./min, of 25% or less.

### TECHNICAL FIELD

The present invention relates to a heat-resistant synthetic resin microporous film and a method for producing the microporous film. The present invention also relates to a separator for a non-aqueous electrolyte secondary battery using the heat-resistant synthetic resin microporous film and to a non-aqueous electrolyte secondary battery using the heat-resistant synthetic resin microporous film.

### BACKGROUND

Lithium-ion secondary batteries are used as power sources for portable electronic devices. Such a lithium-ion secondary battery typically includes a positive electrode, a negative electrode, and a separator all disposed in an electrolyte. The positive electrode is formed by applying lithium cobalt oxide or lithium manganese oxide to the surface of an aluminum foil. The negative electrode is formed by applying carbon to the surface of a copper foil. The separator is disposed so as to separate the positive electrode from the negative electrode to prevent an electrical short circuit between the electrodes.

During charging of the lithium-ion secondary battery, lithium ions are released from the positive electrode and move into the negative electrode. During discharging of the lithium-ion secondary battery, lithium ions are released from the negative electrode and move to the positive electrode.

As the separator, a polyolefin-based resin microporous film is used because it is excellent in insulation properties and has a high cost efficiency. The polyolefin-based resin microporous film undergoes large heat shrinkage at about the melting point of the polyolefin-based resin. For example, when a short circuit between the electrodes occurs as a result of damage to the separator due to contamination with metal foreign matters or the like, generation of Joule heat increases the battery temperature, which leads to the heat shrinkage of the polyolefin-based resin microporous film. The heat shrinkage of the polyolefin-based resin microporous film accelerates a short circuit and further increases the battery temperature.

In recent years, lithium-ion secondary batteries have been desired to have high output power and high safety. Therefore, there is also a need to improve the heat resistance of separators.

Patent Literature 1 discloses a separator for a lithium-ion secondary battery, in which the separator has been treated with electron beam irradiation and the value thereof obtained by thermomechanical analysis (TMA) at 100° C. is 0% to −1%. However, the separator for a lithium-ion secondary battery that has been treated only with electron beam irradiation has poor heat resistance.

### CITATION LIST

### Patent Literature

Patent Literature 1: Japanese Patent Application Laid-Open No. 2003-22793

### SUMMARY OF INVENTION

### Technical Problem

The present invention provides a heat-resistant synthetic resin microporous film having good ion permeability and good heat resistance, and a method for producing the microporous film. The present invention further provides a separator for a non-aqueous electrolyte secondary battery using the heat-resistant synthetic resin microporous film, and a non-aqueous electrolyte secondary battery using the heat-resistant synthetic resin microporous film.

### Means for Solving Problem

A heat-resistant synthetic resin microporous film of the present invention includes

a synthetic resin microporous film that has micropore parts; and

a coating layer that is formed on at least part of the surface of the synthetic resin microporous film, the coating layer containing a polymer of a polymerizable compound that has two or more radical-polymerizable functional groups per molecule, wherein

the heat-resistant synthetic resin microporous film has a maximum heat shrinkage rate, when heated from 25° C. to 180° C. at a rate of temperature increase of 5° C./min, of 25% or less.

That is, the heat-resistant synthetic resin microporous film of the present invention includes a synthetic resin microporous film that has micropore parts, and a coating layer that is formed on at least part of the surface of the synthetic resin microporous film,

the coating layer contains a polymer of a polymerizable compound that has two or more radical-polymerizable functional groups per molecule, and

the heat-resistant synthetic resin microporous film has the maximum heat shrinkage rate, when heated from 25° C. to 180° C. at a rate of temperature increase of 5° C./min, of 25% or less.

A method for producing the heat-resistant synthetic resin microporous film of the present invention includes:

an applying step of applying a polymerizable compound that has two or more radical-polymerizable functional groups per molecule to the surface of a synthetic resin microporous film that has micropore parts; and

an irradiating step of irradiating, with active energy rays, the synthetic resin microporous film to which the polymerizable compound has been applied.

A separator for a non-aqueous electrolyte secondary battery and a non-aqueous electrolyte secondary battery of the present invention include the above-described heat-resistant synthetic resin microporous film.

### Advantageous Effects of Invention

The present invention provides a heat-resistant synthetic resin microporous film that has good ion permeability and good heat resistance.

### BRIEF DESCRIPTION OF THE DRAWING

FIG. 1 is a schematic view of a plasma treatment apparatus.

### DESCRIPTION OF EMBODIMENTS

### Heat-Resistant Synthetic Resin Microporous Film

The heat-resistant synthetic resin microporous film of the present invention includes a synthetic resin microporous film that has micropore parts, and a coating layer that is formed on at least part of the surface of the synthetic resin microporous film.

(Synthetic Resin Microporous Film)

As the synthetic resin microporous film, any microporous film that has been used as a separator in conventional secondary batteries, such as lithium-ion secondary batteries, can be used without any particular limitation. The synthetic resin microporous film is preferably an olefin-based resin microporous film. The olefin-based resin microporous film is easy to undergo deformation or heat shrinkage at high temperature due to melting of the olefin-based resin. The coating layer of the present invention can impart good heat resistance to the olefin-based resin microporous film as described below.

The olefin-based resin microporous film contains an olefin-based resin. The olefin-based resin is preferably an ethylene-based resin or a propylene-based resin, and more preferably a propylene-based resin. Therefore, the olefin-based resin microporous film is preferably an ethylene-based resin microporous film and a propylene-based resin microporous film, and more preferably a propylene-based resin microporous film.

Examples of the propylene-based resin include homopolypropylene and copolymers of propylene and other olefins. When the synthetic resin microporous film is produced by a stretching method, homopolypropylene is preferable. Such propylene-based resins may be used alone or in combination of two or more. Copolymers of propylene and other olefins may be either block copolymers or random copolymers. The amount of a propylene component contained in the propylene-based resin is preferably 50% by weight or more, and more preferably 80% by weight or more.

Examples of olefins to be copolymerized with propylene include α-olefins, such as ethylene, 1-butene, 1-pentene, 4-methyl-1-pentene, 1-hexene, 1-octene, 1-nonene, and 1-decene. Ethylene is preferable.

Examples of the ethylene-based resin include ultra-low-density polyethylene, low-density polyethylene, linear low-density polyethylene, medium-density polyethylene, high-density polyethylene, ultra-high-density polyethylene, and ethylene-propylene copolymers. The ethylene-based resin microporous film may contain another olefin-based resin as long as the microporous film contains an ethylene-based resin. The amount of an ethylene component contained in the ethylene-based resin is preferably more than 50% by weight, and more preferably 80% by weight or more.

The weight average molecular weight of the olefin-based resin is preferably 250,000 to 500,000, and more preferably 280,000 to 480,000. The olefin-based resin having a weight average molecular weight falling within the above-described range can provide an olefin-based resin microporous film having good film formation stability and containing uniform micropore parts formed therein.

The molecular weight distribution (weight average molecular weight Mw/number average molecular weight Mn) of the olefin-based resin is preferably 7.5 to 12, and more preferably 8 to 11. The olefin-based resin having a molecular weight distribution falling within the above-described range can provide an olefin-based resin microporous film having high surface porosity and good mechanical strength.

The weight average molecular weight and the number average molecular weight of the olefin-based resin are values measured by the GPC (gel permeation chromatography) method in terms of polystyrene. Specifically, 6 to 7 mg of the olefin-based resin is collected and the collected olefin-based resin is supplied to a test tube. To the test tube, an o-DCB (ortho-dichlorobenzene) solution containing 0.05% by weight of BHT (dibutylhydroxytoluene) is added such that the olefin-based resin is diluted to have a concentration of 1 mg/mL, to prepare a diluted liquid.

The diluted liquid is shaken at a rotational speed of 25 rpm at 145° C. for 1 hour by using a dissolving and filtering device to dissolve the olefin-based resin in the o-DCB solution, which provides a test sample. The weight average molecular weight and the number average molecular weight of the olefin-based resin can be measured by the GPC method using this test sample.

The weight average molecular weight and the number average molecular weight of the olefin-based resin can be measured by, for example, the following measurement apparatus and measurement conditions.

Measurement Apparatus

Trade name “HLC-8121 GPC/HT” available from Tosoh Corporation

### Measurement Conditions

Column: TSKgel GMHHR-H(20)HT×3
TSKguard column-HHR(30)HT×1

Mobile phase: o-DCB 1.0 mL/min

Sample concentration: 1 mg/mL

Detector: Bryce-type refractometer

Standard substance: Polystyrene (available from Tosoh Corporation, molecular weight: 500 to 8,420,000)

Elution condition: 145° C.

SEC temperature: 145° C.

The melting point of the olefin-based resin is preferably 160 to 170° C., and more preferably 160 to 165° C. The olefin-based resin having a melting point falling within the above-described range can provide an olefin-based resin microporous film that has good film formation stability and suppresses reduction in mechanical strength at high temperature.

In the present invention, the melting point of the olefin-based resin can be measured according to the following procedure using a differential scanning calorimeter (for example, device name “DSC220C” available from Seiko Instruments Inc.). First, 10 mg of the olefin-based resin is heated from 25° C. to 250° C. at a rate of temperature increase of 10° C./min, and held at 250° C. for 3 minutes. Next, the olefin-based resin is cooled from 250° C. to 25° C. at a rate of temperature decrease of 10° C./min, and held at 25° C. for 3 minutes. Subsequently, the olefin-based resin is reheated from 25° C. to 250° C. at a rate of temperature increase of 10° C./min. The endothermic peak temperature in this reheating process is taken as the melting point of the olefin-based resin.

The synthetic resin microporous film contains micropore parts. The micropore parts preferably penetrate through in the film thickness direction, which imparts good gas permeability to the heat-resistant synthetic resin microporous film. Such a heat-resistant synthetic resin microporous film allows ions, such as lithium ions, to permeate therethrough in the thickness direction.

The degree of gas permeability of the synthetic resin microporous film is preferably 50 to 600 sec/100 mL, and more preferably 100 to 300 sec/100 mL. The synthetic resin microporous film having the degree of gas permeability falling within the above-described range can provide a heat-resistant synthetic resin microporous film having both good mechanical strength and good ion permeability.

The degree of gas permeability of the synthetic resin microporous film is a value obtained by measuring the degree of gas permeability at ten points with 10-cm intervals in the longitudinal direction of the synthetic resin microporous film in accordance with JIS P8117 in an atmosphere at a temperature of 23° C. and a relative humidity of 65% and calculating the arithmetic average value of the degree of gas permeability.

The surface porosity of the synthetic resin microporous film is preferably 25 to 55% and more preferably 30 to 50%. The synthetic resin microporous film having a surface porosity falling within the above-described range can provide a heat-resistant synthetic resin microporous film having both good mechanical strength and good ion permeability.

The surface porosity of the synthetic resin microporous film can be measured in the following manner. First, a measurement part having a flat rectangular shape of 9.6 μm in width×12.8 μm in length is selected in any section on the surface of the synthetic resin microporous film and photographed at a magnification of ×10,000.

Next, micropore parts formed in the measurement part are enclosed by rectangles whose long sides or short sides are parallel to the longitudinal direction (stretching direction) of the synthetic resin microporous film. This rectangle is adjusted so as to minimize the length of both the long sides and the short sides. The area of the rectangle is taken as the opening area of each micropore part. The total opening area S (μm²) of the micropore parts is calculated by summing the opening areas of the micropore parts. The total opening area S (μm²) of the micropore parts is divided by 122.88 μm² (9.6 μm×12.8 μm) and multiplied by 100 to obtain a surface porosity (%). With regard to micropore parts across the measurement part and the non-measurement part, only part of the micropore parts in the measurement part is targeted for measurement.

The thickness of the synthetic resin microporous film is preferably 1 to 100 μm and more preferably 5 to 50 μm.

In the present invention, the thickness of the synthetic resin microporous film can be measured in the following manner. That is, the thickness is measured at any ten points in the synthetic resin microporous film by using a dial gauge, and the arithmetic average value of the thickness is taken as the thickness of the synthetic resin microporous film.

The synthetic resin microporous film is more preferably an olefin-based resin microporous film produced by a stretching method. The olefin-based resin microporous film produced by a stretching method is easy to undergo heat shrinkage particularly at high temperature due to residual strain generated by stretching. According to the present invention, good heat resistance can be imparted to the olefin-based resin microporous film as described below.

Specific examples of the method for producing the olefin-based resin microporous film by a stretching method include a method (1) including a step of obtaining an olefin-based resin film by extruding an olefin-based resin, a step of generating and growing crystalline lamellae in the olefin-based resin film, and a step of obtaining an olefin-based resin microporous film containing micropore parts formed by stretching the olefin-based resin film and accordingly making spaces between the crystalline lamellae; and a method (2) including a step of obtaining an olefin-based resin film by extruding an olefin-based resin composition containing an olefin-based resin and a filler and a step of obtaining an olefin-based resin microporous film containing micropore parts by uniaxially stretching or biaxially stretching the olefin-based resin film and accordingly separating the olefin-based resin from the filler. The method (1) is preferred because an olefin-based resin microporous film containing many uniform micropore parts is obtained.

In the present invention, a layered synthetic resin microporous film in which two or more synthetic resin microporous films having different melting points are integrally layered can also be used. In the layered synthetic resin microporous film, two or more synthetic resin microporous films each containing a synthetic resin having a different melting point are layered. Examples include a two-layer structure in which two synthetic resin microporous films having different melting points are layered and a three-layer structure in which three synthetic resin microporous films having different melting points are layered.

In the layered synthetic resin microporous film, a difference in melting point between the synthetic resin microporous films is preferably 10° C. or more. When such a layered synthetic resin microporous film is heated to a certain temperature or higher, the microporous parts in a synthetic resin microporous film having a low melting point are clogged and this synthetic resin microporous film can exert a so-called shutdown function. At this time, a synthetic resin microporous film having a high melting point does not melt even at a shutdown temperature and thus can prevent a short circuit between electrodes.

The layered synthetic resin microporous film preferably includes an ethylene-based resin microporous film containing an ethylene-based resin and a propylene-based resin microporous film containing a propylene-based resin. Preferable examples of suitable layered structures include, but are not particularly limited to, a two-layer structure in which a propylene-based resin microporous film is integrally layered on one surface of an ethylene-based resin microporous film, and a three-layer structure in which propylene-based resin microporous films are integrally layered on both surfaces of an ethylene-based resin microporous film.

The melting point of the ethylene-based resin microporous film is preferably lower than the melting point of the propylene-based resin microporous film. Thus, the ethylene-based resin microporous film can exert a shutdown function. A method for producing the ethylene-based resin microporous film is not particularly limited and can be any publicly known method.

A difference (Tₘₚ−Tₘₑ) between the melting point (Tₘₑ) of the ethylene-based resin microporous film and the melting point (Tₘₚ) of the propylene-based resin microporous film is preferably 10° C. or more, more preferably 20° C. or more, and particularly preferably 30° C. or more.

The ethylene-based resin microporous film and the propylene-based resin microporous film may contain additives, such as a substance for accelerating porosification and a lubricant. Examples of the additives include modified polyolefin resins, alicyclic saturated hydrocarbon resins or modified products thereof, ethylene copolymers, waxes, polymer fillers, organic fillers, inorganic fillers, metal soaps, fatty acids, fatty acid ester compounds, and fatty acid amide compounds.

A method for producing the layered synthetic resin microporous film can be any publicly known method. Specific examples of the production method include a method (1) including a step of obtaining a layered synthetic resin film by co-extruding an olefin-based resin film having a low melting point and an olefin-based resin film having a high melting point and a step of obtaining a layered synthetic resin microporous film by stretching the layered synthetic resin film to form micropore parts; a method (2) including a step of obtaining a layered synthetic resin film by separately extruding an olefin-based resin film having a low melting point and an olefin-based resin film having a high melting point and layering these films and a step of obtaining a layered synthetic resin microporous film by stretching the layered synthetic resin film to form micropore parts; and a method (3) including a step of obtaining an olefin-based resin microporous film by separately extruding an olefin-based resin film having a low melting point and an olefin-based resin film having a high melting point and stretching each olefin-based resin film to form micropore parts and a step of integrally layering these olefin-based resin microporous films.

When such a layered synthetic resin microporous film is used, a coating layer is formed on the surface of at least one synthetic resin microporous film selected from synthetic resin microporous films included in the layered synthetic resin microporous film. Coating layers may be formed on the surfaces of all the synthetic resin microporous films.

When the coating layer is formed on only the surface of any one of synthetic resin microporous films included in the layered synthetic resin microporous film, the coating layer is preferably formed on the surface of a synthetic resin microporous film having a high melting point. This can provide a heat-resistant synthetic resin microporous film that exerts a shutdown function and also has good heat resistance.

For example, when the layered synthetic resin microporous film includes an ethylene-based resin microporous film and a propylene-based resin microporous film, the coating layer is preferably formed on at least the surface of the propylene-based resin microporous film.

When the coating layers are formed on the surfaces of all the synthetic resin microporous films, any of the methods (1) to (3) described above can be used as a method for producing the layered synthetic resin microporous film. When the coating layer is formed on the surface of any one of the synthetic resin microporous films, the method (2) described above can be used as a method for producing the layered synthetic resin microporous film.

(Coating Layer)

The heat-resistant synthetic resin microporous film of the present invention has a coating layer formed on at least part of the surface of the synthetic resin microporous film. The coating layer contains a polymer of a polymerizable compound having two or more radical-polymerizable functional groups per molecule. The coating layer containing such a polymer has high hardness as well as appropriate elasticity and appropriate degree of elongation. Therefore, the use of the coating layer containing the above-described polymer can provide a heat-resistant synthetic resin microporous film that has improved heat resistance and suppresses reduction in mechanical strength such as piercing strength.

The coating layer is formed on at least part of the surface of the synthetic resin microporous film, preferably formed on the entire surface of the synthetic resin microporous film, and more preferably formed on the surface of the synthetic resin microporous film and the wall surfaces of the micropore parts continuous with the surface of the synthetic resin microporous film.

The use of the polymerizable compound allows the coating layer to be formed on the surface of the synthetic resin microporous film without clogging the micropore parts of the synthetic resin microporous film. This can provide a heat-resistant synthetic resin microporous film having good gas permeability and good ion permeability.

The polymerizable compound has two or more radical-polymerizable functional groups per molecule. The radical-polymerizable functional group is a functional group containing a radical-polymerizable unsaturated bond that can be radically polymerized by irradiation with active energy rays. Examples of the radical-polymerizable functional group include, but are not particularly limited to, a (meth)acryloyl group and a vinyl group. A (meth)acryloyl group is preferred.

Examples of the polymerizable compound include polyfunctional acrylic monomers having two or more radical-polymerizable functional groups per molecule, vinyl oligomers having two or more radical-polymerizable functional groups per molecule, modified polyfunctional (meth)acrylates having two or more (meth)acryloyl groups per molecule, dendritic polymers having two or more (meth)acryloyl groups, and urethane (meth)acrylate oligomers having two or more (meth)acryloyl groups.

In the present invention, the term “(meth)acrylate” refers to acrylate or methacrylate. The term “(meth)acryloyl” refers to acryloyl and methacryloyl. The term “(meth)acrylic acid” refers to acrylic acid or methacrylic acid.

The polyfunctional acrylic monomer has two or more radical-polymerizable functional groups per molecule. The polyfunctional acrylic monomer is preferably a tri- or more functional acrylic monomer having three or more radical-polymerizable functional groups per molecule, and more preferably a trifunctional to hexafunctional acrylic monomer.

Examples of the polyfunctional acrylic monomer include

bifunctional acrylic monomers, such as 1,9-nonanediol di(meth)acrylate, 1,4-butanediol di(meth)acrylate, 1,6-hexanediol di(meth)acrylate, tripropylene glycol di(meth)acrylate, 2-hydroxy-3-acryloyloxypropyl di(meth)acrylate, ethylene glycol di(meth)acrylate, diethylene glycol di(meth)acrylate, triethylene glycol di(meth)acrylate, 1,10-decanediol di(meth)acrylate, neopentyl glycol di(meth)acrylate, glycerol di(meth)acrylate, tricyclodecane dimethanol di(meth)acrylate;

tri- or more functional acrylic monomers, such as trimethylolpropane tri(meth)acrylate, pentaerythritol tri(meth)acrylate, ethoxylated isocyanuric acid tri(meth)acrylate, ε-caprolactone-modified tris-(2-acryloxyethyl) isocyanurate, and ethoxylated glycerol tri(meth)acrylate;

tetrafunctional acrylic monomers, such as pentaerythritol tetra(meth)acrylate, ditrimethylolpropane tetra(meth)acrylate, and ethoxylated pentaerythritol tetra(meth)acrylate; and

pentafunctional acrylic monomers, such as dipentaerythritol penta(meth)acrylate; and

hexafunctional acrylic monomers, such as dipentaerythritol hexa(meth)acrylate.

Examples of the vinyl oligomer include, but are not particularly limited to, polybutadiene oligomers. The term “polybutadiene oligomer” refers to an oligomer having a butadiene skeleton. Examples of the polybutadiene oligomer include polymers containing a butadiene component as a monomer component. Examples of the monomer component of the polybutadiene oligomer include a 1,2-butadiene component and a 1,3-butadiene component. Of these, a 1,2-butadiene component is preferred.

The vinyl oligomer may have hydrogen atoms at both terminals of the main chain. The hydrogen atom at each terminal may be substituted by a hydroxy group, a carboxy group, a cyano group, and a hydroxyalkyl group, such as a hydroxyethyl group. The vinyl oligomer may have a radical-polymerizable functional group, such as an epoxy group, a (meth)acryloyl group, or a vinyl group, at a side chain or a terminal of the molecular chain.

Examples of the polybutadiene oligomer include

polybutadiene oligomers, such as a poly(1,2-butadiene) oligomer and a poly(1,3-butadiene) oligomer;

epoxidized polybutadiene oligomers in which an epoxy group has been introduced to the molecule by epoxidation of at least part of carbon-carbon double bonds included in the butadiene skeleton; and

polybutadiene (meth)acrylate oligomers having a butadiene skeleton and having a (meth)acryloyl group at a side chain or a terminal of the main chain.

The polybutadiene oligomer may be a commercially available product. Examples of the poly(1,2-butadiene) oligomer include trade names “B-1000,” “B-2000,” and “B-3000” available from Nippon Soda Co., Ltd. Examples of the polybutadiene oligomer having hydroxy groups at respective terminals of the main chain include trade names “G-1000,” “G-2000,” and “G-3000” available from Nippon Soda Co., Ltd. Examples of the epoxidized polybutadiene oligomer include trade names “JP-100” and “JP-200” available from Nippon Soda Co., Ltd. Examples of the polybutadiene (meth)acrylate oligomer include trade names “TE-2000,” “EA-3000,” and “EMA-3000” available from Nippon Soda Co., Ltd.

The modified polyfunctional (meth)acrylate has two or more radical-polymerizable functional groups per molecule. The modified polyfunctional (meth)acrylate is preferably a modified tri- or more functional (meth)acrylate having three or more radical-polymerizable functional groups per molecule, and more preferably a modified trifunctional to hexafunctional (meth)acrylate having three to six radical-polymerizable functional groups per molecule.

Examples of the modified polyfunctional (meth)acrylate include alkylene oxide-modified polyfunctional (meth)acrylate and caprolactone-modified polyfunctional (meth)acrylate.

An alkylene oxide-modified polyfunctional (meth)acrylate is preferably obtained by esterifying an alkylene oxide adduct of polyalcohol with (meth)acrylic acid. A caprolactone-modified polyfunctional (meth)acrylate is preferably obtained by esterifying a caprolactone adduct of polyalcohol with (meth)acrylic acid.

Examples of the polyalcohol in the alkylene oxide-modified product and the caprolactone-modified product include trimethylolpropane, glycerol, pentaerythritol, ditrimethylolpropane, and tris(2-hydroxyethyl)isocyanuric acid.

Examples of the alkylene oxide in the alkylene oxide-modified product include ethylene oxide, propylene oxide, isopropylene oxide, and butylene oxide.

Examples of the caprolactone in the caprolactone-modified product include ε-caprolactone, δ-caprolactone, and γ-caprolactone.

In the alkylene oxide-modified polyfunctional (meth)acrylate, the average addition molar number of the alkylene oxide is 1 mol or more per radical-polymerizable functional group. The average addition molar number of the alkylene oxide is preferably 1 mol or more and 4 mol or less, and more preferably 1 mol or more and 3 mol or less per radical-polymerizable functional group.

Examples of the modified trifunctional (meth)acrylate include

caprolactone-modified trimethylolpropane tri(meth)acrylate, and alkylene oxide-modified trimethylolpropane tri(meth)acrylates, such as ethylene oxide-modified trimethylolpropane tri(meth)acrylate, propylene oxide-modified trimethylolpropane tri(meth)acrylate, isopropylene oxide-modified trimethylolpropane tri(meth)acrylate, butylene oxide-modified trimethylolpropane tri(meth)acrylate, and ethylene oxide-propylene oxide-modified trimethylolpropane tri(meth)acrylate;

caprolactone-modified glyceryl tri(meth)acrylate, and alkylene oxide-modified glyceryl tri(meth)acrylates, such as ethylene oxide-modified glyceryl tri(meth)acrylate, propylene oxide-modified glyceryl tri(meth)acrylate, isopropylene oxide-modified glyceryl tri(meth)acrylate, butylene oxide-modified glyceryl tri(meth)acrylate, and ethylene oxide-propylene oxide-modified glyceryl tri(meth)acrylate;

caprolactone-modified pentaerythritol tri(meth)acrylate, and alkylene oxide-modified pentaerythritol tri(meth)acrylates, such as ethylene oxide-modified pentaerythritol tri(meth)acrylate, propylene oxide-modified pentaerythritol tri(meth)acrylate, isopropylene oxide-modified pentaerythritol tri(meth)acrylate, butylene oxide-modified pentaerythritol tri(meth)acrylate, and ethylene oxide-propylene oxide-modified pentaerythritol tri(meth)acrylate; and

caprolactone-modified tris-(2-acryloxyethyl) isocyanurate, and alkylene oxide-modified tris-(2-acryloxyethyl) isocyanurate, such as ethylene oxide-modified tris-(2-acryloxyethyl) isocyanurate, propylene oxide-modified tris-(2-acryloxyethyl) isocyanurate, isopropylene oxide-modified tris-(2-acryloxyethyl) isocyanurate, butylene oxide-modified tris-(2-acryloxyethyl) isocyanurate, and ethylene oxide-propylene oxide-modified tris-(2-acryloxyethyl) isocyanurate.

Examples of modified tetrafunctional (meth)acrylates include

caprolactone-modified pentaerythritol tetra(meth)acrylate and alkylene oxide-modified pentaerythritol tetra(meth)acrylates, such as ethylene oxide-modified pentaerythritol tetra(meth)acrylate, propylene oxide-modified pentaerythritol tetra(meth)acrylate, isopropylene oxide-modified pentaerythritol tetra(meth)acrylate, butylene oxide-modified pentaerythritol tetra(meth)acrylate, and ethylene oxide-propylene oxide-modified pentaerythritol tetra(meth)acrylate; and

caprolactone-modified ditrimethylolpropane tetra(meth)acrylate and alkylene oxide-modified ditrimethylolpropane tetra(meth)acrylates, such as ethylene oxide-modified ditrimethylolpropane tetra(meth)acrylate, propylene oxide-modified ditrimethylolpropane tetra(meth)acrylate, isopropylene oxide-modified ditrimethylolpropane tetra(meth)acrylate, butylene oxide-modified ditrimethylolpropane tetra(meth)acrylate, and ethylene oxide-propylene oxide-modified ditrimethylolpropane tetra(meth)acrylate.

Specific examples of modified penta- or more functional (meth)acrylates include caprolactone-modified dipentaerythritol poly(meth)acrylate and alkylene oxide-modified dipentaerythritol poly(meth)acrylates, such as ethylene oxide-modified dipentaerythritol poly(meth)acrylate, propylene oxide-modified dipentaerythritol poly(meth)acrylate, isopropylene oxide-modified dipentaerythritol poly(meth)acrylate, butylene oxide-modified dipentaerythritol poly(meth)acrylate, and ethylene oxide-propylene oxide-modified dipentaerythritol poly(meth)acrylate.

A commercially available product can also be used as modified polyfunctional (meth)acrylate.

Examples of the ethylene oxide-modified trimethylolpropane tri(meth)acrylate include trade names “SR454,” “SR499,” and “SR502” available from Sartomer Company, Inc.; trade name “Viscoat #360” available from Osaka Organic Chemical Industry Ltd.; and trade names “Miramer M3130,” “Miramer M3160,” and “Miramer M3190” available from Miwon Specialty Chemical Co., Ltd. Examples of the propylene oxide-modified trimethylolpropane tri(meth)acrylate include trade names “SR492” and “CD501” available from Sartomer Company, Inc., and trade name “Miramer M360” available from Miwon Specialty Chemical Co., Ltd. Examples of the isopropylene oxide-modified trimethylolpropane tri(meth)acrylate include trade name “TPA-330” available from Nippon Kayaku Co., Ltd.

Examples of the ethylene oxide-modified glyceryl tri(meth)acrylate include trade names “A-GYL-3E” and “A-GYL-9E” available from Shin-Nakamura Chemical Co., Ltd. Examples of the propylene oxide-modified glyceryl tri(meth)acrylate include trade names “SR9020” and “CD9021” available from Sartomer Company, Inc. Examples of the isopropylene oxide-modified glyceryl tri(meth)acrylate include trade name “GPO-303” available from Nippon Kayaku Co., Ltd.

Examples of the caprolactone-modified tris-(2-acryloxyethyl) isocyanurate include trade names “A-9300-1CL” and “A-9300-3CL” available from Shin-Nakamura Chemical Co., Ltd.

Examples of the ethylene oxide-modified pentaerythritol tetra(meth)acrylate include trade name “Miramer M4004” available from Miwon Specialty Chemical Co., Ltd. Examples of the ethylene oxide-modified ditrimethylolpropane tetra(meth)acrylate include trade name “AD-TMP-4E” available from Shin-Nakamura Chemical Co., Ltd.

Examples of the ethylene oxide-modified dipentaerythritol polyacrylate include trade name “A-DPH-12E” available from Shin-Nakamura Chemical Co., Ltd. Examples of the isopropylene oxide-modified dipentaerythritol polyacrylate include trade name “A-DPH-6P” available from Shin-Nakamura Chemical Co., Ltd.

The term “dendritic polymer having two or more (meth)acryloyl groups per molecule” refers to a spherical macromolecule having a radial assembly of branched molecules having a (meth)acryloyl group.

Examples of the dendritic polymer having (meth)acryloyl groups include dendrimers having two or more (meth)acryloyl groups per molecule, and hyperbranched polymers having two or more (meth)acryloyl groups per molecule.

The term “dendrimer” refers to a spherical polymer obtained by spherically assembling a (meth)acrylate using the (meth)acrylate as a branched molecule.

The dendrimer has two or more (meth)acryloyl groups per molecule. The dendrimer is preferably a tri- or more functional dendrimer having three or more (meth)acryloyl groups per molecule and more preferably a polyfunctional dendrimer having 5 to 20 (meth)acryloyl groups per molecule.

The weight average molecular weight of the dendrimer is preferably 1,000 to 50,000, and more preferably 1,500 to 25,000. The dendrimer having the weight average molecular weight falling within the above-described range can make the bonding density in the dendrimer molecule and the bonding density between the dendrimer molecules “high” and “low”, respectively, which allows formation of the coating layer having high hardness as well as appropriate elasticity and appropriate degree of elongation.

The weight average molecular weight of the dendrimer is a value obtained by using gel permeation chromatography (GPC) in terms of polystyrene.

A commercially available product can also be used as a dendritic polymer having two or more (meth)acryloyl groups per molecule. Examples of the dendrimer having two or more (meth)acryloyl groups per molecule include trade names “CN2302,” “CN2303,” and “CN2304” available from Sartomer Company, Inc.; trade names “V1000,” “SUBARU-501” and “SIRIUS-501” available from Osaka Organic Chemical Industry Ltd.; and “A-HBR-5” available from Shin-Nakamura Chemical Co., Ltd.

The term “hyperbranched polymer having two or more (meth)acryloyl groups per molecule” refers to a spherical polymer obtained by modifying, with a (meth)acryloyl group, the surface and inside of a highly branched structure body having an irregularly branched structure obtained by polymerizing an ABx-type polyfunctional monomer (where A and B are functional groups that react with each other, and x, which is the number of B, is 2 or more).

Urethane (meth)acrylate oligomers having (meth)acryloyl groups have two or more (meth)acryloyl groups per molecule.

A urethane acrylate oligomer is obtained by, for example, causing reactions of a polyisocyanate compound, a (meth)acrylate having a hydroxyl group or an isocyanate group, and a polyol compound.

Examples of the urethane acrylate oligomer include a urethane acrylate (1) obtained by causing a reaction between a (meth)acrylate having a hydroxyl group and a terminal isocyanate group-containing urethane prepolymer obtained by causing a polyol compound and a polyisocyanate compound to react, and a urethane acrylate oligomer (2) obtained by causing a reaction between a (meth)acrylate having an isocyanate group and a terminal hydroxyl group-containing urethane prepolymer obtained by causing a polyol compound and a polyisocyanate compound to react.

Examples of the polyisocyanate compound include isophorone diisocyanate, 2,4-tolylene diisocyanate, 2,6-tolylene diisocyanate, 1,3-xylylene diisocyanate, 1,4-xylylene diisocyanate, and diphenylmethane-4,4′-diisocyanate.

Examples of the (meth)acrylate having a hydroxyl group include 2-hydroxyethyl (meth)acrylate, 2-hydroxypropyl (meth)acrylate, 2-hydroxybutyl (meth)acrylate, 4-hydroxybutyl (meth)acrylate, and polyethylene glycol (meth)acrylate. Examples of the (meth)acrylate having an isocyanate group include methacryloyloxyethyl isocyanate.

Examples of the polyol compound include polyol compounds, such as alkylene-type polyol compounds, polycarbonate-type polyol compounds, polyester-type polyol compounds, and polyether-type polyol compounds. Specific examples include polyethylene glycol, polypropylene glycol, polytetramethylene glycol, polycarbonate diols, polyester diols, and polyether diols.

A commercially available product can also be used as a urethane (meth)acrylate oligomer having two or more (meth)acryloyl groups per molecule. Examples of the commercially available product include trade name “UA-122P” available from Shin-Nakamura Chemical Co., Ltd.; trade name “UF-8001G” available from Kyoeisha Chemical Co., Ltd.; trade names “CN977,” “CN999,” “CN963,” “CN985,” “CN970,” “CN133,” “CN975,” and “CN997” available from Sartomer Company, Inc.; trade name “IRR214-K” available from Daicel-Allnex-Ltd.; and trade names “UX-5000,” “UX-5102D-M20,” “UX-5005,” and “DPHA-40H” available from Nippon Kayaku Co., Ltd. As the polymerizable compound, an aliphatic special oligomer, such as trade name “CN113” available from Sartomer Company, Inc. can also be used.

Among the above-described polymerizable compounds, polyfunctional acrylic monomers are preferred, and trimethylolpropane tri(meth)acrylate, pentaerythritol tri(meth)acrylate, pentaerythritol tetra(meth)acrylate, dipentaerythritol hexa(meth)acrylate, and ditrimethylolpropane tetra(meth)acrylate are preferred in the present invention. These compounds can impart good heat resistance to the heat-resistant synthetic resin microporous film without reducing mechanical strength.

When a polyfunctional acrylic monomer is used as the polymerizable compound, the amount of the polyfunctional acrylic monomer contained in the polymerizable compound is preferably 30% by weight or more, more preferably 80% by weight or more, and particularly preferably 100% by weight. The use of the polymerizable compound containing 30% by weight or more of the polyfunctional acrylic monomer can impart good heat resistance to the resulting heat-resistant synthetic resin microporous film without reducing gas permeability.

In the present invention, the above-described polymerizable compounds may be used alone or in combination of two or more as the polymerizable compound.

Part of the polymer in the coating layer and part of the synthetic resin in the synthetic resin microporous film are preferably chemically bonded to each other. The use of the coating layer containing such a polymer can provide a heat-resistant synthetic resin microporous film that exhibits reduced heat shrinkage under high temperature and thus has good heat resistance as described above. Examples of the chemical bonding include, but are not particularly limited to, covalent bonding, ionic bonding, and intermolecular bonding.

(Method for Producing Coating Layer)

A method for producing the coating layer includes

an applying step of applying a polymerizable compound having two or more radical-polymerizable functional groups per molecule to the surface of a synthetic resin microporous film (hereinafter also referred to simply as an “applying step”); and

an irradiating step of irradiating, with active energy rays, the synthetic resin microporous film to which the polymerizable compound has been applied (hereinafter also referred to simply as an “irradiating step”).

(Applying Step)

The method of the present invention first involves performing an applying step of applying a polymerizable compound having two or more radical-polymerizable functional groups per molecule to the surface of a synthetic resin microporous film having micropore parts.

The polymerizable compound can be attached to the surface of the synthetic resin microporous film by applying the polymerizable compound to the surface of the synthetic resin microporous film. At this time, the polymerizable compound may be applied as it is to the surface of the synthetic resin microporous film. However, preferably, the polymerizable compound is dispersed or dissolved in a solvent to obtain an application liquid, and this application liquid is applied to the surface of the synthetic resin microporous film. The use of the polymerizable compound in the form of an application liquid in this way allows the polymerizable compound to be uniformly attached to the surface of the synthetic resin microporous film. A coating layer is uniformly formed accordingly, which enables production of a heat-resistant synthetic resin microporous film having highly improved heat resistance. Moreover, the use of the polymerizable compound as an application liquid can reduce clogging of the micropore parts in the synthetic resin microporous film due to the polymerizable compound. Therefore, the heat resistance of the heat-resistant synthetic resin microporous film can be improved without reducing gas permeability.

Furthermore, the application liquid can be adjusted to have low viscosity. Therefore, when the application liquid is applied to the surface of the synthetic resin microporous film, the application liquid can flow smoothly also on the wall surfaces of the micropore parts in the synthetic resin microporous film, so that the coating layer can be formed not only on the surface of the synthetic resin microporous film but also on the wall surfaces of the opening ends in the micropore parts continuous with the surface of the synthetic resin microporous film. Coating layer parts thus spreading on the wall surfaces of the opening ends in the micropore parts have a function of an anchor effect. Consequently, the coating layer can be strongly integrated with the surface of the synthetic resin microporous film. Such a coating layer can impart good heat resistance to the heat-resistant synthetic resin microporous film. Even if the heat-resistant synthetic resin microporous film is unexpectedly exposed to a heating condition, the coating layer can suppress shrinkage or melting of the heat-resistant synthetic resin microporous film.

Since the polymerizable compound having two or more radical-polymerizable functional groups has good compatibility with the synthetic resin microporous film, the polymerizable compound can be applied to the synthetic resin microporous film without clogging the micropore parts. This enables formation of the coating layer having through-holes that penetrate in the thickness direction in parts corresponding to the micropore parts of the synthetic resin microporous film. Therefore, such a coating layer can provide a heat-resistant synthetic resin microporous film having improved heat resistance without reducing gas permeability.

The solvent used for the application liquid is not limited to a particular solvent as long as the polymerizable compound can be dissolved or dispersed therein. Examples of the solvent include alcohols such as methanol, ethanol, propanol, and isopropyl alcohol; ketones such as acetone, methyl ethyl ketone, and methyl isobutyl ketone; ethers, such as tetrahydrofuran and dioxane; and ethyl acetate, and chloroform. Of these, ethyl acetate, ethanol, methanol, and acetone are preferred. These solvents can be smoothly removed after applying the application liquid to the surface of the synthetic resin microporous film. Furthermore, the above-described solvents are highly safe because of low reactivity with an electrolyte contained in secondary batteries, such as lithium-ion secondary batteries.

The amount of the polymerizable compound contained in the application liquid is preferably 3 to 20% by weight and more preferably 5 to 15% by weight. The amount of the polymerizable compound falling within the above-described range allows uniform formation of the coating layer on the surface of the synthetic resin microporous film without clogging the micropore parts. Thus, the heat-resistant synthetic resin microporous film having improved heat resistance can be produced without reducing gas permeability.

Examples of a method for applying the polymerizable compound to the surface of the synthetic resin microporous film include, but are not particularly limited to, a method (1) of applying the polymerizable compound to the surface of the synthetic resin microporous film; a method (2) of applying the polymerizable compound to the surface of the synthetic resin microporous film by immersing the synthetic resin microporous film in the polymerizable compound; a method (3) involving preparing an application liquid by dissolving or dispersing the polymerizable compound in a solvent, applying the application liquid to the surface of the synthetic resin microporous film, and then removing the solvent by heating the synthetic resin microporous film; and a method (4) involving preparing an application liquid by dissolving or dispersing the polymerizable compound in a solvent, applying the application liquid to the synthetic resin microporous film by immersing the synthetic resin microporous film in the application liquid, and then removing the solvent by heating the synthetic resin microporous film. Of these methods, the above-described methods (3) and (4) are preferred. By these methods, the polymerizable compound can be uniformly applied to the surface of the synthetic resin microporous film.

In the methods (3) and (4) described above, the temperature at which the synthetic resin microporous film is heated for removing the solvent can be set according to the type and boiling point of the solvent used. The temperature at which the synthetic resin microporous film is heated for removing the solvent is preferably 50 to 140° C., and more preferably 70 to 130° C. The heating temperature falling within the above-described range enables effective removal of the applied solvent while the heat shrinkage of the synthetic resin microporous film and clogging of the micropore parts are reduced.

In the methods (3) and (4) described above, the time during which the synthetic resin microporous film is heated for removing the solvent is not particularly limited and can be set according to the type and boiling point of the solvent used. The time during which the synthetic resin microporous film is heated for removing the solvent is preferably 0.02 to 60 minutes, and more preferably 0.1 to 30 minutes.

As described above, the polymerizable compound can be attached to the surface of the synthetic resin microporous film by applying the polymerizable compound or the application liquid to the surface of the synthetic resin microporous film.

(Irradiating Step)

The method of the present invention next involves performing the irradiating step of irradiating, with active energy rays, the synthetic resin microporous film to which the polymerizable compound has been applied. This irradiating step induces polymerization of the polymerizable compound and causes integral formation of the coating layer containing a polymer of the polymerizable compound on at least part of the surface, preferably the entire surface, of the synthetic resin microporous film.

Irradiation with active energy rays may decompose part of the synthetic resin contained in the synthetic resin microporous film to reduce the mechanical strength, such as tearing strength, of the synthetic resin microporous film. However, the coating layer containing a polymer of the polymerizable compound has high hardness as well as appropriate elasticity and appropriate degree of elongation. Therefore, appropriate elasticity and appropriate degree of elongation of the coating layer can compensate for a reduction in the mechanical strength of the synthetic resin microporous film. The coating layer thus suppresses reduction in the mechanical strength of the heat-resistant synthetic resin microporous film while improving heat resistance.

Examples of the active energy ray include, but are not particularly limited to, an electron beam, plasma, ultraviolet rays, an electron beam, α-rays, β-rays, and γ-rays.

When an electron beam is used as an active energy ray, the accelerating voltage of the electron beam on the synthetic resin microporous film is preferably 50 to 300 kV and more preferably 50 to 250 kV, which is not particularly limitative. The accelerating voltage of the electron beam falling within the above-described range allows formation of the coating layer while deterioration of the synthetic resin in the synthetic resin microporous film is reduced.

When an electron beam is used as an active energy ray, the electron beam irradiation dose on the synthetic resin microporous film is preferably 10 to 150 kGy and more preferably 10 to 100 kGy, which is not particularly limitative. The electron beam irradiation dose falling within the above-described range allows formation of the coating layer while deterioration of the synthetic resin in the synthetic resin microporous film is reduced.

When plasma is used as an active energy ray, the plasma energy density on the synthetic resin microporous film is preferably 5 to 50 J/cm², more preferably 10 to 45 J/cm², and particularly preferably 20 to 45 J/cm², which is not particularly limitative.

The plasma treatment can be performed by, for example, exposing the synthetic resin microporous film, to which the polymerizable compound has been applied, to plasma generated by electric discharge in a plasma generating gas. The plasma treatment activates the polymerizable compound to polymerize the compound.

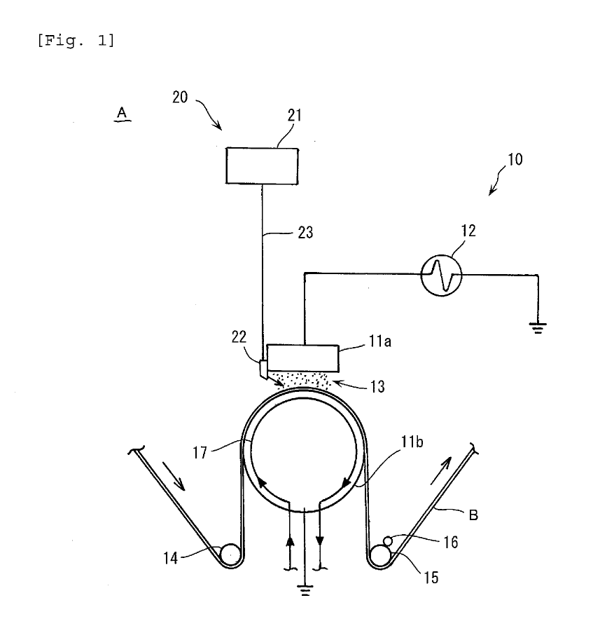

The plasma treatment can be performed using a publicly known plasma treatment apparatus. FIG. 1 is a schematic view of a plasma treatment apparatus suitably used in the method of the present invention.

A plasma treatment apparatus A illustrated in FIG. 1 includes a plasma-generating device 10 and a plasma-generating-gas introducing device 20.

The plasma-generating device 10 includes a pair of electrodes 11a and 11b, which are disposed to face to each other with a predetermined interval therebetween, and a power source 12. The first electrode 11a has a plate shape, and the second electrode 11b has a roll shape. The electrodes 11a and 11b may have any shape. The electrodes 11a and 11b both may have a plate shape or a roll shape. Instead, the second electrode 11b may have a roll shape, and the first electrode 11a may have an arc shape along the circumference surface of the other electrode 11b. At least one of the opposing surfaces of the electrodes 11a and 11b is coated with a solid dielectric.

The first electrode 11a is disposed to face to the circumference surface of the second electrode 11b with a predetermined interval therebetween. A space 13 is defined between the pair of electrodes 11a and 11b. The first electrode 11a is connected to the power source 12, and the second electrode 11b is grounded electrically.

The plasma-generating-gas introducing device 20 further includes a gas supply source 21 filled with a plasma generating gas, and a nozzle 22 having, at its lower end, an discharge orifice (not shown) through which the plasma generating gas is to be discharged into the space 13. The gas supply source 21 and the nozzle 22 are connected to each other through a pipe 23.

A synthetic resin microporous film B, to which a polymerizable compound has been applied, is placed around a guide roll 14 disposed on the film feed-in side and is guided to the other electrode 11b having a roll shape. The synthetic resin microporous film B is then placed around about upper half of the circumference surface of the second electrode 11b so as to pass through between the pair of electrodes 11a and 11b. The synthetic resin microporous film B is then placed around a guide roll 15 disposed on the film feed-out side. The other electrode 11b can be rotated by a rotation mechanism (not shown). A drive roll 16 is disposed in contact with the guide roll 15 disposed on the film feed-out side, and the guide roll 15 can rotate following the drive roll 16. The synthetic resin microporous film B can be continuously fed by rotating the electrode 11b and the guide roll 15.

The electrode 11b includes a temperature-controlling path 17 formed thereinside. The surface temperature of the electrode 11b can be controlled by circulating a temperature-controlled medium, such as temperature-controlled water, in the temperature-controlling path 17. The surface temperature of the synthetic resin microporous film B placed on the circumference surface of the electrode 11b can be controlled accordingly.

Next, a method for plasma-treating, by using the above-described plasma treatment apparatus, the synthetic resin microporous film B to which the polymerizable compound has been applied will be described. First, the synthetic resin microporous film B is placed around each of the guide roll 14, the second electrode 11b, and the guide roll 15. The synthetic resin microporous film B is then continuously fed so as to pass through the space 13 by rotating the electrode 11b and the guide roll 15. The space 13 serves as a discharge space by applying a pulse-wave voltage to the electrode 11a from the power source 12. The plasma generating gas is introduced to the nozzle 22 from the gas supply source 21 through the pipe 23, and then discharged from the discharge orifice (not shown) of the nozzle 22 into the space 13. The plasma generating gas is accordingly converted into plasma in the discharge space 13, and the synthetic resin microporous film B can be exposed in plasma and thus treated with plasma.

In the plasma treatment process, the surface temperature of the synthetic resin microporous film B to which the radical-polymerizable monomer has been applied is preferably 15° C. to 100° C. The surface temperature falling within the above-described range can reduce generation of wrinkles on the synthetic resin microporous film B due to thermal expansion.

As a plasma generating gas, an inert gas is preferred. Examples of the inert gas include a nitrogen gas, an argon gas, and a helium gas. The use of the inert gas reduces the oxygen concentration in the discharge space 13 and reduces inhibition of a polymerization reaction of the radical-polymerizable monomer by oxygen.

When ultraviolet rays are used as active energy rays, the integrated dose of ultraviolet rays on the synthetic resin microporous film is preferably 1000 to 5000 mJ/cm², more preferably 1000 to 4000 mJ/cm², and particularly preferably 1500 to 3700 mJ/cm². When ultraviolet rays are used as active energy rays, the application liquid preferably contains a photopolymerization initiator. Examples of the photopolymerization initiator include benzophenone, benzyl, methyl-o-benzoylbenzoate, and anthraquinone.

Ultraviolet rays, an electron beam, and plasma are preferred as active energy rays, and an electron beam is particularly preferred. Since the electron beam has appropriate high energy, irradiation with the electron beam sufficiently generates radicals in the synthetic resin in the synthetic resin microporous film and thus can form many chemical bonds between part of the synthetic resin and part of the polymer of the polymerizable compound.

The amount of the coating layer contained in the heat-resistant synthetic resin microporous film is preferably 5 to 80 parts by weight, more preferably 5 to 60 parts by weight, and particularly preferably 10 to 40 parts by weight, with respect to 100 parts by weight of the synthetic resin microporous film. The amount of the coating layer falling within the above-described range allows uniform formation of the coating layer on the surface of the synthetic resin microporous film without clogging the micropore parts. This can provide a heat-resistant synthetic resin microporous film having improved heat resistance without reducing gas permeability.

The thickness of the coating layer is preferably 1 to 100 nm, and more preferably 5 to 50 nm, which is not particularly limitative. The thickness of the coating layer falling within the above-described range allows uniform formation of the coating layer on the surface of the synthetic resin microporous film without clogging the micropore parts. This can provide a heat-resistant synthetic resin microporous film having improved heat resistance without reducing gas permeability.

The heat resistance of the heat-resistant synthetic resin microporous film can be improved even if the heat-resistant synthetic resin microporous film does not contain any inorganic particles. Thus, the heat-resistant synthetic resin microporous film preferably contains no inorganic particle. However, the heat-resistant synthetic resin microporous film may contain inorganic particles as desired. Examples of the inorganic particles include inorganic particles commonly used in a heat-resistant porous layer. Examples of the material constituting the inorganic particles include Al₂O₃, SiO₂, TiO₂, and MgO.

(Heat-Resistant Synthetic Resin Microporous Film)

The heat-resistant synthetic resin microporous film of the present invention includes the synthetic resin microporous film, and the coating layer formed on at least part of the surface of the synthetic resin microporous film, as described above.

The maximum heat shrinkage rate of the heat-resistant synthetic resin microporous film when the heat-resistant synthetic resin microporous film is heated from 25° C. to 180° C. at a rate of temperature increase of 5° C./min is preferably 25% or less, more preferably 0 to 25%, and still more preferably 1 to 17%, which is not particularly limitative. The occurrence of the heat shrinkage of the heat-resistant synthetic resin microporous film under high temperature is suppressed by the coating layer, and the heat-resistant synthetic resin microporous film has thus good heat resistance. Therefore, the maximum heat shrinkage rate of the heat-resistant synthetic resin microporous film is 25% or less.

The maximum heat shrinkage rate of the heat-resistant synthetic resin microporous film can be measured in the following manner. First, the heat-resistant synthetic resin microporous film is cut into a specimen having a flat rectangular shape (3 mm in width×30 mm in length). At this time, the extrusion direction (longitudinal direction) of the heat-resistant synthetic resin microporous film is parallel to the longitudinal direction of the specimen. The both ends of the specimen in the longitudinal direction are supported by jigs and attached to a TMA measuring device (for example, trade name “TMA-SS6000” available from Seiko Instruments Inc.). At this time, the distance between the jigs is 10 mm, and the jigs can move in accordance with the heat shrinkage of the specimen. Then, the specimen is heated from 25° C. to 180° C. at a rate of temperature increase of 5° C./min while a tension of 19.6 mN (2 gf) is applied to the specimen in the longitudinal direction. The distance L (mm) between the jigs is measured at each temperature. The heat shrinkage rate is calculated on the basis of the following formula, and the maximum value is taken as the maximum heat shrinkage rate.

Heat shrinkage rate (%)=100×(10−L)/10

The degree of gas permeability of the heat-resistant synthetic resin microporous film is preferably 50 to 600 sec/100 mL, and more preferably 100 to 300 sec/100 mL, which is not particularly limitative. In the heat-resistant synthetic resin microporous film, as described above, formation of the coating layer suppresses clogging of the micropore parts in the synthetic resin microporous film, which suppresses reduction in gas permeability due to formation of the coating layer. Therefore, the heat-resistant synthetic resin microporous film has a degree of gas permeability falling within the above-described range. The heat-resistant synthetic resin microporous film having the degree of gas permeability falling within the above-described range has good ion permeability.

As a method for measuring the degree of gas permeability of the heat-resistant synthetic resin microporous film, the same method as the above-described method for measuring the degree of gas permeability of the synthetic resin microporous film is used.

The surface porosity of the heat-resistant synthetic resin microporous film is preferably 20 to 60%, more preferably 30 to 55%, and particularly preferably 30 to 50%, which is not particularly limitative. As described above, formation of the coating layer suppresses clogging of the micropore parts in the synthetic resin microporous film and thus the heat-resistant synthetic resin microporous film has a surface porosity falling within the above-described range. The heat-resistant synthetic resin microporous film having a surface porosity falling within the above-described range has both good mechanical strength and good ion permeability.

As a method for measuring the surface porosity of the synthetic resin microporous film, the same method as the above-described method for measuring the surface porosity of the synthetic resin microporous film is used.

The gel fraction of the heat-resistant synthetic resin microporous film is preferably 5% by weight or more and more preferably 10% by weight or more. A gel fraction of 5% by weight or more results in firm formation of the coating layer containing the polymerizable compound and thus allows the heat-resistant synthetic resin microporous film to exhibit reduced heat shrinkage. The gel fraction of the heat-resistant synthetic resin microporous film is preferably 99% by weight or less and more preferably 90% by weight or less. A gel fraction of 99% by weight or less allows the heat-resistant synthetic resin microporous film to have improved heat resistance.

In the present invention, the gel fraction can be measured in the following procedure. First, the heat-resistant synthetic resin microporous film is cut into about 0.1 g of a specimen. The weight [W₁ (g)] of this specimen is measured, and the specimen is then placed in a test tube. Next, 20 ml of xylene is poured into the test tube, and the specimen is entirely immersed in xylene. The test tube is covered with an aluminum cap, and the test tube is immersed for 24 hours in an oil bath heated to 130° C. The content in the test tube taken out of the oil bath is readily placed in a stainless steel mesh basket (#200) before the temperature decreases, and insoluble matters are filtered out. The weight [W₀ (g)] of the mesh basket is measured in advance. The mesh basket and the residue are dried under reduced pressure at 80° C. for 7 hours, and then the total weight [W₂ (g)] of the mesh basket and the residue is measured. The gel fraction is calculated according to the following equation.

Gel fraction [% by weight]=100×(W₂−W₀)/W₁

[Separator for Non-Aqueous Electrolyte Secondary Battery]

The heat-resistant synthetic resin microporous film of the present invention as described above has good gas permeability and allows lithium ions to permeate therethrough smoothly and uniformly. Furthermore, the heat-resistant synthetic resin microporous film of the present invention suppresses the occurrence of heat shrinkage under high temperature and has good heat resistance. Since the heat-resistant synthetic resin microporous film of the present invention does not need to include inorganic particles in the coating layer, the heat-resistant synthetic resin microporous film is lightweight and is not associated with contamination of the production line due to separation of inorganic particles during the production process.

Therefore, the heat-resistant synthetic resin microporous film of the present invention is suitably used as a separator for a non-aqueous electrolyte secondary battery. Examples of the non-aqueous electrolyte secondary battery include lithium-ion secondary batteries. Since the heat-resistant synthetic resin microporous film has good lithium ion permeability, the use of this heat-resistant synthetic resin microporous film can provide a non-aqueous electrolyte secondary battery that can be charged and discharged at high current density. Furthermore, since the heat-resistant synthetic resin microporous film has good heat resistance, the use of the heat-resistant synthetic resin microporous film can provide a non-aqueous electrolyte secondary battery in which an electrical short circuit between electrodes due to the shrinkage of the heat-resistant synthetic resin microporous film is prevented even when the temperature inside the battery increases to, for example, 100 to 150° C., particularly 130 to 150° C.

[Non-Aqueous Electrolyte Secondary Battery]

The non-aqueous electrolyte secondary battery is not particularly limited as long as it includes the heat-resistant synthetic resin microporous film of the present invention as a separator. The non-aqueous electrolyte secondary battery includes a positive electrode, a negative electrode, a separator including the heat-resistant synthetic resin microporous film, and a non-aqueous electrolyte. The heat-resistant synthetic resin microporous film is disposed between the positive electrode and the negative electrode, and accordingly can prevent an electrical short circuit between the electrodes. At least the micropore parts of the heat-resistant synthetic resin microporous film are filled with the non-aqueous electrolyte, and thus lithium ions can move between the electrodes during charging and discharging.

The positive electrode preferably includes a positive electrode current collector and a positive electrode active material layer formed on at least one surface of the positive electrode current collector, which are not particularly limitative. The positive electrode active material layer preferably contains a positive electrode active material and voids formed between molecules of the positive electrode active material. When the positive electrode active material layer contains voids, the voids are also filled with the non-aqueous electrolyte. The positive electrode active material is a material that can intercalate and deintercalate lithium ions or the like. Examples of the positive electrode active material include lithium cobalt oxide and lithium manganese oxide. Examples of the current collector used in the positive electrode include an aluminum foil, a nickel foil, and a stainless steel foil. The positive electrode active material layer may further contain a binder, a conductive auxiliary agent, and the like.

The negative electrode preferably includes a negative electrode current collector and a negative electrode active material layer formed on at least one surface of the negative electrode current collector, which are not particularly limitative. The negative electrode active material layer preferably contains a negative electrode active material and voids formed between molecules of the negative electrode active material. When the negative electrode active material layer contains voids, the voids are also filled with the non-aqueous electrolyte. The negative electrode active material is a material that can intercalate and deintercalate lithium ions or the like. Examples of the negative electrode active material include graphite, carbon black, acetylene black, and Ketjen black. Examples of the current collector used in the negative electrode include a copper foil, a nickel foil, and a stainless steel foil. The negative electrode active material layer may further contain a binder, a conductive auxiliary agent, and the like.

The non-aqueous electrolyte is an electrolyte in which an electrolyte salt is dissolved in a solvent containing no water. Examples of the non-aqueous electrolyte used in a lithium-ion secondary battery include a non-aqueous electrolyte in which a lithium salt is dissolved in an aprotic organic solvent. Examples of the aprotic organic solvent include solvent mixtures of cyclic carbonates, such as propylene carbonate and ethylene carbonate, and linear carbonates, such as diethyl carbonate, methyl ethyl carbonate, and dimethyl carbonate. Examples of the lithium salt include LiPF₆, LiBF₄, LiClO₄, and LiN(SO₂CF₃)₂.

The heat-resistant synthetic resin microporous film of the present invention has a coating layer containing a polymer of a polymerizable compound having two or more radical-polymerizable functional groups. The coating layer can also improve the wettability of the heat-resistant synthetic resin microporous film with the non-aqueous electrolyte. The heat-resistant synthetic resin microporous film thus allows the non-aqueous electrolyte to easily permeate into the micropore parts thereof, and can uniformly hold a large amount of the non-aqueous electrolyte. Therefore, the use of the heat-resistant synthetic resin microporous film as a separator can provide a non-aqueous electrolyte secondary battery that can be produced with high productivity and suppresses reduction in lifetime due to deterioration of the electrolyte.

### EXAMPLES

The present invention will be described in more detail by way of Examples but the present invention is not limited by these Examples.

### Examples 1 to 14 and Comparative Example 1

### 1. Production of Homopolypropylene Microporous Film

(Extruding Step)

A homopolypropylene (weight average molecular weight: 400,000, number average molecular weight: 37,000, melt flow rate: 3.7 g/10 min, isotactic pentad fraction measured by ¹³C-NMR method: 97%, melting point: 165° C.) was supplied to a uniaxial extruder and melt-kneaded at a resin temperature of 200° C. Next, the melt-kneaded homopolypropylene was extruded onto a cast roll having a surface temperature of 95° C. from a T-die attached to the tip of the uniaxial extruder, and was cooled by application of cool air until the surface temperature of the homopolypropylene reached 30° C. This provided a long homopolypropylene film (200 mm in width). The extrusion rate was 10 kg/h, the film forming speed was 22 m/min, and the draw ratio was 83.

(Curing Step)

The obtained long homopolypropylene film (50 m in length) was rolled around a cylindrical core having an outer diameter of 3 inches to obtain a homopolypropylene film roll. The homopolypropylene film roll was cured by allowing it to stand for 24 hours in an air-heating furnace in which the temperature of an atmosphere where this roll was placed was 150° C. At this time, the temperature of the entire homopolypropylene film from the surface to the inside of the roll was the same temperature as the temperature inside the air-heating furnace.

(First Stretching Step)

Next, the homopolypropylene film was unrolled from the cured homopolypropylene film roll and then uniaxially stretched in only the extrusion direction with a uniaxial stretching device at a stretching speed of 50%/min and a stretching rate of 1.2 such that the surface temperature of the homopolypropylene film was 20° C.

(Second Stretching Step)

Subsequently, the homopolypropylene film was uniaxially stretched in only the extrusion direction with a uniaxial stretching device at a stretching speed of 42%/min and a stretching rate of 2.3 such that the surface temperature was 125° C.

(Annealing Step)

Subsequently, annealing was performed by heating the homopolypropylene film for 4 minutes such that the surface temperature reached 155° C. and accordingly 6% shrinking the homopolypropylene film. As a result, a homopolypropylene microporous film (thickness: 25 μm, weight: 9.8 g/m²) was obtained.

In the obtained homopolypropylene microporous film, the degree of gas permeability was 115 sec/100 mL, the surface porosity was 33%, the maximum major diameter of opening ends in the micropore parts was 620 nm, the average major diameter of the opening ends in the micropore parts was 380 nm, and the pore density was 22 pores/μm².

### 2. Formation of Coating Layer

(Applying Step)

An application liquid was preparing by dissolving, in the predetermined amount of ethyl acetate shown in Tables 1 and 2, a polymerizable compound, which was trimethylolpropane triacrylate (TMPTA), trimethylolpropane trimethacrylate (TMPTMA), dipentaerythritol hexaacrylate (DPHA), pentaerythritol triacrylate (PETA), pentaerythritol tetraacrylate (PETTA), ditrimethylolpropane tetraacrylate (DTMPTTA), 1,9-nonanediol dimethacrylate (NDMA), 1,4-butanediol dimethacrylate (BDDA), tripropylene glycol diacrylate (TPGDA), 1,9-nonanediol dimethacrylate (NDA), tricyclo decanedimethanol diacrylate (TCDDMDA), or ethoxylated isocyanuric acid triacrylate (EIATA), in the predetermined amount shown in Tables 1 and 2. This application liquid was applied to the surface of the homopolypropylene microporous film.

Next, the homopolypropylene microporous film was heated at 80° C. for 2 minutes to evaporate and remove ethyl acetate. As a result, the polymerizable compound was attached to the homopolypropylene microporous film in the amount of the polymerizable compound shown in Tables 1 and 2 with respect to 100 parts by weight of the homopolypropylene microporous film.

(Irradiating Step)

The homopolypropylene microporous film was irradiated with an electron beam at the accelerating voltage and the absorbed dose shown in Tables 1 and 2 under a nitrogen atmosphere. The electron beam irradiation induced polymerization of the polymerizable compound and caused integral formation of a coating layer containing a polymer of the polymerizable compound on the entire surface, including the wall surfaces of the micropore parts, of the homopolypropylene microporous film to provide a heat-resistant homopolypropylene microporous film. Part of the homopolypropylene contained in the homopolypropylene microporous film was chemically bonded to part of the polymer contained in the coating layer. The heat-resistant homopolypropylene microporous film had the thickness shown in Tables 1 and 2. The amount (parts by weight) of the coating layer contained in the heat-resistant homopolypropylene microporous film with respect to 100 parts by weight of the homopolypropylene microporous film is shown in Tables 1 and 2.

In Comparative Example 1, a homopolypropylene microporous film was obtained without performing the applying step or the irradiating step.

### Example 15

### 1. Production of Layered Synthetic Resin Microporous Film

A long homopolypropylene film (200 mm in width) was obtained by using the homopolypropylene used in Example 1 with a uniaxial extruder having a T-die in the same manner as in Example 1. The film thickness was 12 μm. It is noted that the extrusion rate was 7 kg/h, the film forming speed was 10 m/min, and the draw ratio was 208.

A high-density polyethylene (density: 0.964 g/cm³, melt flow rate: 5.2 g/10 min, melting point: 135° C.) was supplied to a uniaxial extruder, and melt-kneaded at a resin temperature of 175° C. Next, the melt-kneaded high-density polyethylene was extruded onto a cast roll having a surface temperature of 90° C. from a T-die attached to the tip of the uniaxial extruder, and was cooled by application of cool air until the surface temperature of the high-density polyethylene reached 30° C. This provided a long high-density polyethylene film (200 mm in width). The extrusion rate was 5 kg/h, the film forming speed was 14.5 m/min, and the draw ratio was 250.

(Curing Step)

The obtained long homopolypropylene film (100 m in length) was rolled around a cylindrical core having an outer diameter of 3 inches to obtain a homopolypropylene film roll. The homopolypropylene film roll was cured by allowing it to stand for 24 hours in an air-heating furnace in which the temperature of an atmosphere where this roll was placed was 150° C. At this time, the temperature of the entire homopolypropylene film from the surface to the inside of the roll was the same temperature as the temperature inside the air-heating furnace.

The obtained long high-density polyethylene film (100 m in length) was rolled around a cylindrical core having an outer diameter of 3 inches to obtain a high-density polyethylene film roll. The obtained high-density polyethylene film roll was cured in the same manner as that for the above-described homopolypropylene film roll. The temperature of the atmosphere in the air-heating furnace was 115° C.

(Layering Step)

Two long homopolypropylene films were unrolled from the homopolypropylene film roll. One long high-density polyethylene film was unrolled from the high-density polyethylene film roll.

These three films were layered in order of the homopolypropylene film, the high-density polyethylene film, and the homopolypropylene film. The three films were then integrated by using a laminating roll to provide a layered synthetic resin film. The laminating roll was a heating roll. The three films were thermally fused with each other and thus integrally layered under conditions of a surface temperature of the laminating roll of 135° C. and a linear pressure of 1.9 kg/cm. The thickness of the layered synthetic resin film was 30 μm.

(First Stretching Step)

Next, the layered synthetic resin film was uniaxially stretched in only the extrusion direction with a uniaxial stretching device at a stretching speed of 50%/min and a stretching rate of 1.2 such that the surface temperature of the layered synthetic resin film was 20° C.

(Second Stretching Step)

Subsequently, the layered synthetic resin film was uniaxially stretched in only the extrusion direction with a uniaxial stretching device at a stretching speed of 42%/min and a stretching rate of 2.5 such that the surface temperature was 125° C.

(Annealing Step)

Subsequently, annealing was performed by heating the layered synthetic resin film for 4 minutes such that the surface temperature reached 127° C. and accordingly 8% shrinking the layered synthetic resin film. As a result, a layered synthetic resin microporous film (thickness: 25 μm) was obtained.

In the obtained layered synthetic resin microporous film, the degree of gas permeability was 590 sec/100 mL, the surface porosity was 26%, the maximum major diameter of opening ends in the micropore parts was 540 nm, the average major diameter of the opening ends in the micropore parts was 340 nm, and the pore density was 21 pores/μm².

### 2. Formation of Coating Layer

(Applying Step)

An application liquid was prepared by dissolving, in the predetermined amount of ethyl acetate shown in Table 3, trimethylolpropane triacrylate (TMPTA) as a polymerizable compound in the predetermined amount shown in Table 3. This application liquid was applied to the surface of the layered synthetic resin microporous film.

Next, the layered synthetic resin microporous film was heated at 80° C. for 2 minutes to evaporate and remove ethyl acetate. As a result, the polymerizable compound (trimethylolpropane triacrylate) is attached to the layered synthetic resin microporous film in the amount of the polymerizable compound shown in Table 3 with respect to 100 parts by weight of the layered synthetic resin microporous film.

(Irradiating Step)

The layered synthetic resin microporous film was irradiated with an electron beam at the accelerating voltage and the absorbed dose shown in Table 3 and under a nitrogen atmosphere. The electron beam irradiation induced polymerization of trimethylolpropane triacrylate (TMPTA) and caused integral formation of a coating layer containing a polymer of trimethylolpropane triacrylate (TMPTA) on the entire surface, including the wall surfaces of the micropore parts, of the layered synthetic resin microporous film to provide a heat-resistant synthetic resin microporous film. Part of the homopolypropylene contained in the layered synthetic resin microporous film was chemically bonded to part of the polymer contained in the coating layer. The heat-resistant synthetic resin microporous film had the thickness shown in Table 3. The amount (parts by weight) of the coating layer contained in the heat-resistant synthetic resin microporous film with respect to 100 parts by weight of the layered synthetic resin microporous film is shown in Table 3.

### Example 16

A homopolypropylene microporous film was produced in the same manner as in Example 1. An application liquid was prepared in the same manner as in Example 1 and applied to the surface of the homopolypropylene microporous film. The homopolypropylene microporous film was heated at 80° C. for 2 minutes to evaporate and remove ethyl acetate. As a result, the polymerizable compound (trimethylolpropane triacrylate) was attached to the homopolypropylene microporous film in the amount of the polymerizable compound shown in Table 4 with respect to 100 parts by weight of the homopolypropylene microporous film.

(Plasma Treatment)

The homopolypropylene microporous film, to which the polymerizable compound has been applied, was treated with plasma six times by using the plasma treatment apparatus shown in FIG. 1 in the following manner. A homopolypropylene microporous film B was placed around each of a guide roll 14, a second electrode 11b, and a guide roll 15. The homopolypropylene microporous film B was then continuously fed so as to pass through between a pair of electrodes 11a and 11b at a feeding speed of 1 m/min by rotating the electrode 11b and the guide roll 15. Water controlled at 15° C. was circulated in a temperature-controlling path 17 disposed inside the electrode 11b. The surface temperature of the homopolypropylene microporous film placed around the second electrode 11b was 15° C.

A space 13 served as a discharge space by applying a pulse-wave voltage to the electrode 11a from a power source 12 under the following conditions. At this time, the pressure inside the discharge space 13 was 10.1×10⁴ Pa (atmospheric pressure). A nitrogen gas, which was a plasma generating gas, was introduced to a nozzle 22 from a gas supply source 21 through a pipe 23, and then the nitrogen gas was discharged from a discharge orifice (not shown) of the nozzle 22 into the space 13. The nitrogen gas was accordingly converted into plasma in the discharge space 13, and the homopolypropylene microporous film B was exposed in plasma and thus treated with plasma. The oxygen concentration in the space 13 between the pair of electrodes 11a and 11b was 480 ppm. The plasma energy density on the homopolypropylene microporous film was 34.8 J/cm².

The plasma treatment induced polymerization of the polymerizable compound (trimethylolpropane triacrylate) and caused integral formation of a coating layer containing a polymer of the polymerizable compound on the entire surface, including the wall surfaces of the micropore parts, of the homopolypropylene microporous film to provide a heat-resistant homopolypropylene microporous film. Part of the homopolypropylene contained in the homopolypropylene microporous film was chemically bonded to part of the polymer contained in the coating layer. The heat-resistant homopolypropylene microporous film had the thickness shown in Table 4. The amount (parts by weight) of the coating layer contained in the heat-resistant homopolypropylene microporous film with respect to 100 parts by weight of the homopolypropylene microporous film is shown in Table 4.

### <Voltage Application Conditions>

Glow discharge

Pulse width: 9 μsec

Rise time: 5 μs

Fall time: 5 μs

Discharge frequency: 15 kHz

Dead time: 2.0 sec

DC voltage: 620 V

Current value: 1.0 A

Supplied power: 0.62 kW

### Example 17

A homopolypropylene microporous film was produced in the same manner as in Example 1.

(UV Irradiating Step)

An application liquid was prepared by dissolving trimethylolpropane triacrylate (TMPTA), which was a polymerizable compound, and benzophenone, which was a photopolymerization initiator, in the predetermined amount of ethyl acetate shown in Table 5. This application liquid was applied to the surface of the homopolypropylene microporous film. Subsequently, the homopolypropylene microporous film was heated at 80° C. for 2 minutes to evaporate and remove the solvent. As a result, the polymerizable compound (TMPTA) and the photopolymerization initiator (benzophenone) were respectively attached to the homopolypropylene microporous film in the amounts with respect to 100 parts by weight of the homopolypropylene microporous film shown in Table 5.

Next, the homopolypropylene microporous film was irradiated with ultraviolet rays at an integrated dose of 3700 mJ/cm² in a vacuum to polymerize TMPTA. A coating layer containing a polymer of TMPTA was integrally formed on the entire surface, including the wall surfaces of the micropore parts, of the homopolypropylene microporous film to provide a heat-resistant homopolypropylene microporous film. Part of the homopolypropylene contained in the homopolypropylene microporous film was chemically bonded to part of the polymer contained in the coating layer. The heat-resistant homopolypropylene microporous film had the thickness shown in Table 5. The amount (parts by weight) of the coating layer contained in the heat-resistant homopolypropylene microporous film with respect to 100 parts by weight of the homopolypropylene microporous film is shown in Table 5.

### Example 18

A heat-resistant homopolypropylene microporous film was produced in the same manner as in Example 1.

(Formation of Ceramic-Coating Layer)

A dispersion liquid was prepared by uniformly dispersing 5 parts by weight of polyvinyl alcohol (average degree of polymerization: 1700, degree of saponification: 99%; or more) and 95 parts by weight of alumina particles (average particle size: 0.4 μm) in 150 parts by weight of water. The dispersion liquid was applied to the surface of the heat-resistant homopolypropylene microporous film by using a wire bar coater. The dispersion liquid was then dried at 60° C. to remove water and, as a result, a ceramic-coating layer having a thickness of 3 μm was formed on the surface of the heat-resistant homopolypropylene microporous film. The total thickness of the heat-resistant homopolypropylene microporous film was 28 μm. The degree of gas permeability of the obtained heat-resistant homopolypropylene microporous film, to which the ceramic-coating layer has been attached, was 180 sec/100 cm³.

[Evaluation]

The heat shrinkage rate of each of the heat-resistant synthetic resin microporous films obtained in Examples and the homopolypropylene microporous film obtained in Comparative Example when heated from 25° C. to 180° C. at a rate of temperature increase of 5° C./min was measured in the above-described manner. The heat shrinkage rates at 130° C. and 150° C. and the maximum heat shrinkage rate are shown in Tables 1 to 6. The heat shrinkage rate of the homopolypropylene microporous film of Comparative Example was measured by the same method as the above-described method for the heat shrinkage rate of the heat-resistant synthetic resin microporous film.

The degree of gas permeability, surface porosity, and gel fraction of each of the heat-resistant synthetic resin microporous films obtained in Examples and the homopolypropylene microporous film obtained in Comparative Example were measured in the above-described manners, and the results are shown in Tables 1 to 5. The gel fraction of the homopolypropylene microporous film of Comparative Example was measured by the same method as the above-described method for the gel fraction of the heat-resistant synthetic resin microporous film. The degree of gas permeability, surface porosity, gel fraction, heat shrinkage rates at 130° C. and 150° C., and maximum heat shrinkage rate of the homopolypropylene microporous film of Comparative Example are shown in the fields of the “heat-resistant homopolypropylene microporous film” in Table 1.

(Nail Penetration Test)

The nail penetration test was performed in the following manner on the heat-resistant synthetic resin microporous films obtained in Examples. The nail penetration test was also performed on the homopolypropylene microporous film obtained in Comparative Example in the same manner as the following manner except that the homopolypropylene microporous film was used instead of the heat-resistant synthetic resin microporous film. The results are shown in Tables 1 to 6.

A positive electrode-forming composition containing nickel-cobalt-lithium manganese oxide (1:1:1) as a positive electrode active material was prepared. This positive electrode-forming composition was applied to one surface of an aluminum foil, which served as a positive electrode current collector, and dried to form a positive electrode active material layer. Subsequently, the positive electrode current collector having the positive electrode active material layer on the one surface was punched out to obtain a positive electrode having a flat rectangular shape of 48 mm in width×117 mm in length.

Next, a negative electrode-forming composition containing natural graphite as a negative electrode active material was prepared. This negative electrode-forming composition was applied to one surface of an aluminum foil, which served as a negative electrode current collector, and dried to form a negative electrode active material layer. Subsequently, the negative electrode current collector having the negative electrode active material layer on the one surface was punched out to obtain a negative electrode having a flat rectangular shape of 50 mm in width×121 mm in length.

The heat-resistant homopolypropylene microporous film was then punched out in a flat rectangular shape of 52 mm in width×124 mm in length.

Next, a layered body was obtained by alternately layering each of positive electrode 10 layers and each of negative electrode 11 layers by intermediary of each heat-resistant synthetic resin microporous film therebetween. Subsequently, a tab lead was bonded to each electrode by ultrasonic welding. The layered body was placed in an exterior material made of aluminum-laminated foil, and the exterior material was heat-sealed to obtain a layered element. A surface pressure of 1 kgf/cm² was applied to the obtained layered element, and the resistance was measured to confirm that no short circuit occurred.

Next, the layered element was dried under a reduced pressure at 80° C. for 24 hours, and an electrolyte was then injected into the layered element under normal temperature and normal pressure in a dry box (dew point: 50° C. or lower). The electrolyte used was a LiPF₆ solution (1 mol/L) containing ethylene carbonate (E) and dimethyl carbonate (D) as solvents in a volume ratio (E:D) of 3:7. After the electrolyte was injected into the layered element, aging, vacuum impregnation, and temporary vacuum sealing were performed.

Next, the layered element after temporary vacuum sealing was stored at 20° C. for 24 hours and then subjected to the initial charging under the conditions of 0.2 CA, constant current and constant voltage (C.C.-C.V.), 4.2 V, and 12-hour cutoff.

Next, the layered element was subjected to degassing under reduced pressure and final sealing, and was then further aged for one week in a charged state (SOC 100%). Subsequently, the layered element was subjected to the initial discharging at 0.2 CA, the second charging and discharging at 0.2 CA, and a five-cycle capacity check test at 1 CA. Subsequently, the alternating-current resistance (ACR) and direct-current resistance (DCR) of each cell were measured under the following conditions.

ACR (SOC 50%, 1 kHz), DCR (SOC 50%, discharging at 1 CA, 2 CA, and 3 CA each for 10 seconds)

The layered element was charged under the conditions of 0.2 CA, constant voltage and constant current (C.C.-C.V.), 4.2 V, and 10-hour cutoff until the layered element was fully charged (SOC 100%). Subsequently, the layered element was subjected to a nail penetration test involving piercing the layered element with a nail having a thickness of φ3 mm and a tip angle of 60° at a piercing speed of 10 mm/sec. In Tables 1 to 6, the terms “good” and “bad” have the following meanings.

Good: No smoke or flame was observed in the layered element after the test.

Bad: At least one of smoke and flame was observed in the layered element after the test.

TABLE 1

| | | | Example | | | | | | |
|---|---|---|---|---|---|---|---|---|---|
| | | | 1 | 2 | 3 | 4 | 5 | 6 | 7 |
| Homopolypro- | Thickness (μm) | | 25 | 25 | 25 | 25 | 25 | 25 | 25 |
| pylene micro- | | | | | | | | | |
| porous film | | | | | | | | | |
| Application | Amount of ethyl acetate (parts by weight) | | 95 | 95 | 95 | 95 | 95 | 95 | 95 |
| liquid | Type of polymerizable compound | | TMPTA | TMPTA | TMPTA | DPHA | TMPTMA | PETA | PETTA |
| | Amount of polymerizable compound | | 5 | 5 | 5 | 5 | 5 | 5 | 5 |
| | (parts by weight) | | | | | | | | |
| Amount of polymerizable compound attached to | | | 15 | 15 | 15 | 18 | 14 | 13 | 14 |
| homopolypropylene microporous film (parts by weight) | | | | | | | | | |
| Electron beam | Accelerating voltage (kV) | | 200 | 200 | 200 | 200 | 200 | 200 | 200 |
| | Absorbed dose (kGy) | | 50 | 25 | 120 | 50 | 50 | 50 | 50 |
| Heat-resistant | Thickness (μm) | | 25 | 25 | 25 | 25 | 25 | 25 | 25 |
| homopolypro- | Amount of coating layer (parts by weight) | | 15 | 15 | 15 | 18 | 14 | 13 | 14 |
| pylene micro- | Thermal | 130° C. | 0.1 | 0.4 | 0 | 0.1 | 0.1 | 0.1 | 0.1 |
| porous film | shrinkage | 150° C. | 2.1 | 2.8 | 1.7 | 1.7 | 2.3 | 2.3 | 2.2 |
| | rate (%) | Maximum thermal | 12.1 | 15.5 | 8.1 | 8.3 | 13.8 | 13 | 12.7 |
| | | shrinkage rate | | | | | | | |

| | | | | | | | |
|---|---|---|---|---|---|---|---|
| Degree of gas permeability | 127 | 129 | 130 | 138 | 120 | 121 | 123 |
| (sec/100 mL) | | | | | | | |
| Surface porosity (%) | 31 | 31 | 31 | 28 | 32 | 32 | 32 |
| Gel fraction (% by weight) | 30 | 27 | 34 | 36 | 25 | 28 | 32 |
| Nail penetration test | Good | Good | Good | Good | Good | Good | Good |

TABLE 2

| | | | | | | | | | | Comparative |
|---|---|---|---|---|---|---|---|---|---|---|
| | | | Example | | | | | | | Example |
| | | | 8 | 9 | 10 | 11 | 12 | 13 | 14 | 1 |
| Homopolypro- | Thickness (μm) | | 25 | 25 | 25 | 25 | 25 | 25 | 25 | 25 |
| pylene micro- | | | | | | | | | | |
| porous film | | | | | | | | | | |
| Application | Amount of ethyl acetate (parts by weight) | | 95 | 95 | 95 | 95 | 90 | 90 | 90 | — |
| liquid | Type of polymerizable compound | | DTMPTTA | NDMA | BDDA | TPGDA | NDA | TCDDMDA | EIATA | — |
| | Amount of polymerizable compound | | 5 | 10 | 10 | 10 | 7 | 7 | 7 | — |
| | (parts by weight) | | | | | | | | | |
| Amount of polymerizable compound attached to | | | 14 | 24 | 26 | 26 | 20 | 20 | 20 | — |
| homopolypropylene microporous film (parts by weight) | | | | | | | | | | |
| Electron beam | Accelerating voltage (kv) | | 200 | 200 | 200 | 200 | 200 | 200 | 200 | Not |
| | | | | | | | | | | irradiated |
| | Absorbed dose (kGy) | | 50 | 100 | 100 | 120 | 70 | 70 | 70 | Not |
| | | | | | | | | | | irradiated |
| Heat-resistant | Thickness (μm) | | 25 | 25 | 25 | 25 | 25 | 25 | 25 | 25 |
| homopolypro- | Amount of coating layer (parts by weight) | | 14 | 22 | 25 | 25 | 20 | 20 | 20 | 0 |
| pylene micro- | Thermal | 130° C. | 0.3 | 0.4 | 0.5 | 0.4 | 0.3 | 0.3 | 0.1 | 4.4 |
| porous film | shrinkage | 150° C. | 3 | 6.5 | 7 | 6.5 | 3 | 3.3 | 1.7 | 23.5 |
| | rate % | Maximum thermal | 16.7 | 23 | 24.1 | 23.3 | 18 | 20 | 14 | 40 [symbol] |
| | | shrinkage rate | | | | | | | | |

| | | | | | | | | |
|---|---|---|---|---|---|---|---|---|
| Degree of gas permeability | 130 | 409 | 480 | 390 | 190 | 210 | 230 | 115 |
| (sec/100 mL) | | | | | | | | |
| Surface porosity (%) | 31 | 24 | 23 | 25 | 25 | 28 | 28 | 33 |
| Gel fraction (% by weight) | 25 | 8 | 6 | 6 | 12 | 15 | 20 | 0 |
| Nail penetration test | Good | Good | Good | Good | Good | Good | Good | Bad |

TABLE 3

| | | | Example |
|---|---|---|---|
| | | | 15 |
| Layered synthetic | Thickness (μm) | | 25 |
| resin microporous | | | |
| film | | | |
| Application liquid | Amount of ethyl acetate (parts by weight) | | 95 |
| | Type of polymerizable compound | | TMPTA |
| | Amount of polymerizable compound | | 5 |
| | (parts by weight) | | |
| Amount of polymerizable compound attached to layered | | | 18 |
| synthetic resin microporous film (parts by weight) | | | |
| Electron beam | Accelerating voltage (kV) | | 200 |
| | Absorbed dose (kGy) | | 50 |
| Heat-resistant | Thickness (μm) | | 25 |
| synthetic resin | Amount of coating layer (parts by weight) | | 18 |
| microporous film | Thermal | 130° C. | 0.5 |
| | shrinkage | 150° C. | 20 |
| | rate (%) | Maximum thermal | 25 |
| | | shrinkage rate | |

| | |
|---|---|
| Degree of gas permeability | 590 |
| (sec/100 mL) | |
| Surface porosity (%) | 26 |
| Gel fraction (% by weight) | 74 |
| Nail penetration test | Good |

TABLE 4

| | | | Example |
|---|---|---|---|
| | | | 16 |
| Homopolypro- | Thickness (μm) | | 25 |
| pylene micro- | | | |
| porous film | | | |
| Application liquid | Amount of ethyl acetate (parts by weight) | | 95 |
| | Type of polymerizable compound | | TMPTA |
| | Amount of polymerizable compound | | 5 |
| | (parts by weight) | | |
| Amount of polymerizable compound attached to | | | 15 |
| homopolypropylene microporous film (parts by weight) | | | |
| Plasma | Energy density (J/cm²) | | 34.8 |
| Heat-resistant | Thickness (μm) | | 25 |
| synthetic resin | Amount of coating layer (parts by weight) | | 15 |
| microporous film | Thermal | 130° C. | 0.1 |
| | shrinkage | 150° C. | 2.3 |
| | rate (%) | Maximum thermal | 14.6 |
| | | shrinkage rate | |

| | |
|---|---|
| Degree of gas permeability | 125 |
| (sec/100 mL) | |
| Surface porosity (%) | 31 |
| Gel fraction (% by weight) | 25 |
| Nail penetration test | Good |

TABLE 5

| | | | Example |
|---|---|---|---|
| | | | 17 |
| Homopolypro- | Thickness (μm) | | 25 |
| pylene micro- | | | |
| porous film | | | |
| Application liquid | Amount of ethyl acetate (parts by weight) | | 94.75 |
| | Type of polymerizable compound | | TMPTA |
| | Amount of polymerizable compound | | 5 |
| | (parts by weight) | | |
| | Amount of photopolymerization | | 0.25 |
| | initiator (parts by weight) | | |
| Amount of polymerizable compound attached to | | | 15 |
| homopolypropylene microporous film (parts by weight) | | | |
| Amount of photopolymerization initiator attached | | | 0.75 |
| to homopolypropylene microporous film (parts by weight) | | | |
| Ultraviolet rays | Integrated dose (mJ/cm²) | | 3700 |
| Heat-resistant | Thickness (μm) | | 25 |
| homopolypro- | Amount of coating layer (parts by weight) | | 15 |
| pylene micro- | Thermal | 130° C. | 0.5 |
| porous film | shrinkage | 150° C. | 7 |
| | rate (%) | Maximum | 24.9 |
| | | thermal rate | |

| | |
|---|---|
| Degree of gas permeability | 128 |
| (sec/100 mL) | |
| Surface porosity (%) | 31 |
| Gel fraction (% by weight) | 10 |
| Nail penetration test | Good |

TABLE 6

| | | | Example |
|---|---|---|---|
| | | | 18 |
| Heat-resistant | Thickness (μm) | | 25 |
| homopolypropylene | | | |
| microporous film | | | |
| Ceramic-coating | Thickness (μm) | | 3 |
| layer | | | |
| Dispersion liquid | Amount of water (parts by weight) | | 150 |
| | Alumina particles (parts by weight) | | 95 |
| | Polyvinyl alcohol (parts by weight) | | 5 |
| Heat-resistant | Thickness (μm) | | 28 |
| homopolypropylene | Thermal | 130° C. | 0 |
| microporous film | shrinkage | 150° C. | 1.6 |
| with ceramic- | rate (%) | Maximum thermal | 8 |
| coating layer | | shrinkage rate | |

| | |
|---|---|
| Degree of gas permeability | 180 |
| (sec/100 mL) | |
| Nail penetration test | Good |

### INDUSTRIAL APPLICABILITY

The heat-resistant synthetic resin microporous film of the present invention is suitably used as a non-aqueous electrolyte secondary battery separator.

### CROSS REFERENCE TO RELATED APPLICATION

This application claims the benefit of Japanese Patent Application No. 2014-94828, filed on May 1, 2014, the disclosure of which is incorporated by reference herein in its entirety.

### REFERENCE SIGNS LIST

11 plasma-generating device
11a, 11b electrode
12 power source
13 space (discharge space)
14 guide roll
15 guide roll
16 drive roll
17 temperature-controlling path
20 plasma-generating-gas introducing device
21 gas supply source
22 nozzle
23 pipe
A plasma treatment apparatus
B synthetic resin microporous film

1. A heat-resistant synthetic resin microporous film comprising:
a synthetic resin microporous film that has micropore parts; and
a coating layer that is formed on at least part of a surface of the synthetic resin microporous film, the coating layer containing a polymer of a polymerizable compound that has two or more radical-polymerizable functional groups per molecule, wherein
the heat-resistant synthetic resin microporous film has a maximum heat shrinkage rate, when heated from 25° C. to 180° C. at a rate of temperature increase of 5° C./min, of 25% or less.

2. The heat-resistant synthetic resin microporous film according to claim 1, wherein the synthetic resin microporous film is a propylene-based resin microporous film.

3. The heat-resistant synthetic resin microporous film according to claim 1, wherein the polymerizable compound that has two or more radical-polymerizable functional groups per molecule is at least one selected from the group consisting of trimethylolpropane tri(meth)acrylate, pentaerythritol tri(meth)acrylate, pentaerythritol tetra(meth)acrylate, dipentaerythritol hexa(meth)acrylate, and ditrimethylolpropane tetra(meth)acrylate.

4. The heat-resistant synthetic resin microporous film according to claim 1, wherein the heat-resistant synthetic resin microporous film has a degree of gas permeability of 50 to 600 sec/100 mL.

5. The heat-resistant synthetic resin microporous film according to claim 1, wherein the heat-resistant synthetic resin microporous film has a gel fraction of 5% or more.

6. A method for producing a heat-resistant synthetic resin microporous film, comprising:
an applying step of applying a polymerizable compound that has two or more radical-polymerizable functional groups per molecule to a surface of a synthetic resin microporous film that has micropore parts; and
an irradiating step of irradiating, with active energy rays, the synthetic resin microporous film to which the polymerizable compound has been applied.

7. The method for producing a heat-resistant synthetic resin microporous film according to claim 6, wherein, in the applying step, an application liquid containing the polymerizable compound dispersed or dissolved in a solvent is applied to the surface of the synthetic resin microporous film.

8. The method for producing a heat-resistant synthetic resin microporous film according to claim 7, wherein, in the applying step, the synthetic resin microporous film to which the application liquid has been applied is heated to remove the solvent.

9. The method for producing a heat-resistant synthetic resin microporous film according to claim 6, wherein, in the irradiating step, the synthetic resin microporous film is irradiated with ionizing radiation in an absorbed dose of 10 to 150 kGy.

10. A separator for a non-aqueous electrolyte secondary battery, comprising the heat-resistant synthetic resin microporous film according to claim 1.

11. A non-aqueous electrolyte secondary battery comprising: a negative electrode; a positive electrode; the separator for a non-aqueous electrolyte secondary battery according to claim 10; and a non-aqueous electrolyte.
